(19) United States
(12) Patent Application Publication
(10) Pub. No.: US 2019/0077684 A1
(43) Pub. Date: Mar. 14, 2019

(54) System for Treating Sewage

(71) Applicant: Randall Duval, Colchester, VT (US)

(72) Inventor: Randall Duval, Colchester, VT (US)

(21) Appl. No.: 16/189,761

(22) Filed: Nov. 13, 2018

Related U.S. Application Data
(63) Continuation-in-part of application No. 15/492,449, filed on Apr. 20, 2017.
(60) Provisional application No. 62/325,694, filed on Apr. 21, 2016.

(51) Int. Cl. C02F 3/20; C02F 1/00; C02F 1/32; C02F 3/10; C02F 1/50

(52) U.S. Cl. CPC C02F 3/20; C02F 1/004; C02F 1/325; C02F 3/109; C02F 2209/42; C02F 2201/322; C02F 2203/006; C02F 2209/40; C02F 1/50

(57) ABSTRACT

A sewage treatment system uses a multi-stage process to treat waste materials. Sewage is contained in a first tank, from which liquid waste is filtered and transferred to a second tank, where the first tank retains solid waste. The second tank may contain a plurality of chambers, with the chambers connected using ports for fluid communication. Liquid waste in the second tank undergoes aerobic digestion, where an aeration device may aid in the digestion process. The second tank may also include a UV light source to reduce bacteria. The treated liquid from the second tank may be clean enough to be discharged directly into a leach field which would not meet standards for conventional leach fields.

### CROSS-REFERENCE TO RELATED APPLICATION

This application is a continuation-in-part of U.S. Utility application Ser. No. 15/492,449, filed Apr. 20, 2017, which claims the benefit of U.S. Provisional Application 62/325,694, filed Apr. 21, 2016

### FEDERALLY-SPONSORED RESEARCH:

None

### BACKGROUND

### Field of the Invention, Related Art

The present disclosure relates to that of sewage treatment. More specifically, to septic systems which treat sewage through the separation of liquid waste from solid waste, and in which contaminants and bacteria in the liquid waste are reduced. In one embodiment, the septic system uses two tanks, with the tanks using a closed-top configuration with a lid, with the tank or tanks preferably buried in the ground. In one embodiment, this septic configuration is used for homes or buildings where there is no municipal sewage disposal system.

A typical conventional septic configuration employs anaerobic digestion of bacteria within the tank, and allows the reduced-bacteria liquid from the tank to drain into a drain or leach field. A tank must be located where soil meets certain standards, such as soil porosity, for the adjoining leach field. Depending on siting constraints, this may require pumping sewage to a location with suitable soil type. Alternately, mound-type systems may be used in locations where soil types are otherwise not suitable as a leach field. Mound systems typically employ two tanks, with the first tank retaining solids, and the second tank metering the amount and timing of liquid waste that exits the system to a soil mound. However, cost and complexity are significant for both mound systems and for systems that require extensive pumping. Further, neither option may be viable in some locations.

### BRIEF SUMMARY OF THE INVENTION

In many sewage systems, solid waste accounts for a much smaller proportion of the total waste stream than do liquids. A two-stage sewage treatment allows solids to first be separated through filtration, with liquid waste then treated separately, preferably in a tank separate from that which retains solid waste. The present system includes treatment methods such as aerobic digestion and exposure to ultraviolet (UV) light sources to then be employed on the liquid waste.

The system described herein provides numerous advantages compared to existing sewage/septic systems, through improved cleaning of the liquid waste portion. Liquid waste is filtered and transferred from a first tank to a second tank, where the first tank retains solid waste. Liquid waste in the second tank, or aeration tank, is treated by aerobic digestion and UV exposure, such that the discharge liquid from the aeration tank may contain only very small amounts of bacteria. The treated liquid may be clean enough to be discharged directly into a leach field which would not meet standards (such as percolation tests) for conventional leach fields.

In one embodiment, there is a device for treating sewage, comprising: a closed-top primary solids tank directly receiving unfiltered sewage, with a filtering device positioned in the primary solids tank to create filtered liquid waste and prevent solid sewage from passing through a link port; a closed-top aeration tank in fluid communication with the primary solids tank via the link port; the aeration tank including at least one vertical dividing wall, the at least one vertical dividing wall forming at least a first chamber and a final chamber; at least one chamber port which places the at least two chambers in fluid communication with one another; an aeration pump connected to at least one bubble diffuser, the at least one bubble diffuser positioned at the aeration tank's bottom in only the first chamber; a UV lightbath positioned in the aeration tank only in the final chamber; and a discharge port through which treated liquid waste exits the aeration tank from the final chamber.

In one embodiment, there is at least one vertical dividing wall is configured to span less than the aeration tank's full height, thereby creating open air exchange within the closed-top aeration tank between the chambers at each chamber's top portion, the filtered liquid waste traveling between the chambers only through the at least one chamber port, the chamber port located below a top edge of each said vertical dividing wall.

In one embodiment, both the closed-top primary solids tank and the closed-top aeration tank are configured to be buried in the ground and are buried in the ground.

In one embodiment, only the closed-top aeration tank includes insulation on its outside surface.

In one embodiment, the final chamber contains a J-tube, the J-tube positioned to receive by gravity in a first end the liquid waste from the at least one chamber port and discharge liquid waste from a second end into the final chamber, the J-tube configured with a 180 degree curve.

In one embodiment the J-tube contains at least one of an anti-bacterial substance and an anti-odor substance.

In one embodiment, there is a device for treating sewage, comprising: a closed-top primary solids tank directly receiving unfiltered sewage, with a filtering device positioned in the primary solids tank to create filtered liquid waste and prevent solid sewage from passing through a link port; a closed-top aeration tank in fluid communication with the primary solids tank via the link port; the aeration tank including three vertical dividing walls, forming a first chamber, a second chamber, a third chamber, and a final chamber; a chamber port in each vertical dividing wall which places: the first chamber in fluid communication with the second chamber, the second chamber in fluid communication with the third chamber; and the third chamber in fluid communication with the final chamber; an aeration pump connected to at least one bubble diffuser, the at least one bubble diffuser positioned at the aeration tank's bottom; a UV lightbath positioned in the aeration tank only in the final chamber; and a discharge port located in the final chamber through which treated liquid waste is pumped by a discharge pump to exit the aeration tank.

In one embodiment, all of the vertical dividing walls are configured to span less than the aeration tank's full height, thereby creating open air exchange within the closed-top aeration tank between the chambers at each chamber's top portion, the liquid waste traveling between the chambers only through the chamber ports, the chamber ports located below a top edge of each said vertical dividing wall.

In one embodiment both the closed-top primary solids tank and the closed-top aeration tank are configured to be buried in the ground and are buried in the ground.

In one embodiment only the closed-top aeration tank includes insulation on its outside surface.

In one embodiment, the final chamber contains a J-tube, the J-tube positioned to receive by gravity in a first end the liquid waste from the third chamber and discharge liquid waste from a second end into the final chamber, the J-tube configured with a 180 degree curve.

In one embodiment, the J-tube contains at least one of an anti-bacterial substance and an anti-odor substance.

In one embodiment, the J-tube is sized to be removable through an access port to the final chamber.

In one embodiment a bubble diffuser of the least one bubble diffuser is included at a bottom of only the first chamber and the second chamber.

In one embodiment the chamber ports are configured on each vertical dividing wall in positions that are vertically aligned and horizontally staggered fore-aft relative to the other chamber port in that chamber.

In one embodiment the discharge pump includes a float switch for cycling the discharge pump on and off.

In one embodiment an alert signals if liquid in the final chamber has exceeded an allowable level.

In one embodiment carriers are included in only the first chamber and the second chamber.

In one embodiment malfunctions related to the aeration pump and the UV light are signaled with an alert.

In one embodiment, there is a method for treating sewage, comprising: placing a closed-top primary solids tank to directly receive unfiltered sewage, with a filtering device positioned in the primary solids tank to create filtered liquid waste and prevent solid sewage from passing through a link port; placing a closed-top aeration tank in fluid communication with the primary solids tank via the link port; configuring the aeration tank including at least one vertical dividing wall, the at least one vertical dividing wall forming at least a first chamber and a final chamber; configuring at least one chamber port which places the at least two chambers in fluid communication with one another; connecting an aeration pump to at least one bubble diffuser, the at least one bubble diffuser positioned at the aeration tank's bottom in only the first chamber; configuring a UV lightbath in the aeration tank only in the final chamber; and pumping out the aeration tank's contents out of the discharge port with a discharge pump, the discharge pump controlled by a float switch.

### BRIEF DESCRIPTION OF THE FIGURES

FIG. 1 is a top plan view of an aeration tank.

FIG. 2 is a cross-sectional view of the an aeration tank taken along line 2-2 of FIG. 1 showing it in use.

FIG. 3 is a schematic showing electrical connections in an embodiment of the system.

FIG. 4 is a cross-sectional view of a primary solids tank positioned next to an aeration tank.

FIG. 5 is a perspective view of a carrier.

### DETAILED DESCRIPTION OF THE INVENTION

The present system receives sewage waste, treating the sewage in multiple steps to first separate out solid waste, before then treating liquid waste Tanks described are typically made from cast concrete in one embodiment; however tanks made of other materials such as metals, plastics, or composites may also be used. One embodiment uses an aeration tank with a rectangular cross section and a volume of 1500 gallons. However, other tank shapes and volumes may also readily be used.

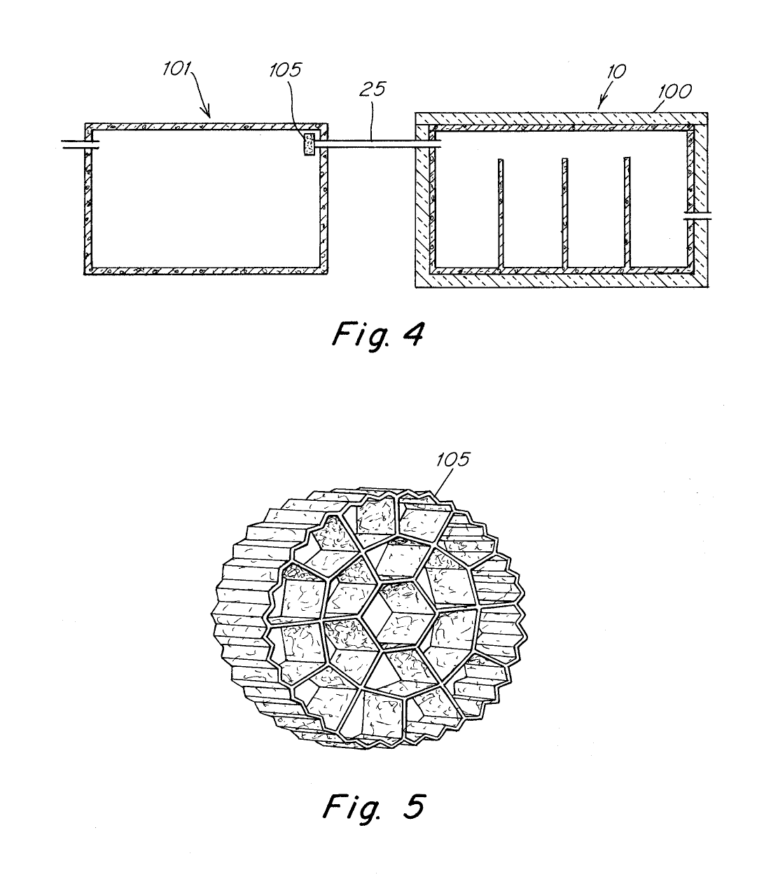

As seen in FIG. 2 and FIG. 4, waste first enters a primary solids tank 101, which includes a link port 25. Link port 25 allows fluid communication between the primary solids tank and an aeration tank 10. The link port 25 is preferably positioned near the top of aeration tank 10. Before liquid travels from the primary solids tank 101 to aeration tank 10, waste in the primary tank is filtered to remove solids using filter 105. Such solids filtration is accomplished by filtering devices known in the art. In one embodiment, filter 105 is placed on the end of link port 25 in the primary solids tank. Other configurations may be used, including but not limited to a filter which may be placed in other locations, and which may be removable for cleaning. Only filtered liquid waste enters link port 25 and therefore aeration tank 10 only receives filtered liquid waste.

Solids tank 101 is configured to receive raw, untreated sewage. For example, the sewage discharge of the kitchen and bathrooms of a home or other building. Aeration tank 10 then receives only filtered liquid waste that is substantially free of solids. In one embodiment, both tanks use a closed-top configuration, with tanks preferably buried in the ground, wherein earth surrounds each tank on at least tank's horizontal bottom and on all vertical sides, and optionally on the tank's horizontal top side. The tanks and related parts are configured to be buried in the ground—this contrasts with systems designed for municipal waste, etc., which may be open top, have components not configured for burying in the earth, etc.

In one embodiment, thermal insulation material surrounds aeration tank 10 on the tank's outside surfaces. Such insulation is a type known in the art, such as polystyrene foam. The insulation helps to maintain preferred temperature for aerobic digestion of bacteria in the filtered waste water in tank 10.

Aeration tank 10 includes at least one vertical dividing wall; in one embodiment aeration tank 10 includes three vertical dividing walls: first dividing wall 15a, second dividing wall 15b, and third dividing wall 15c. In one embodiment, the dividing walls are made of concrete, cast as part of tank 10; however, other configurations may be used for the wall structures. These three dividing walls separate aeration tank 10 into four chambers: first chamber 20a, second chamber 20b, third chamber 20c, and fourth chamber 20d. The forth chamber 20d may also be called the final chamber. Chamber ports 35 place said chambers in fluid communication with one another. In one embodiment, chamber ports are 1 inch circular openings. In one embodiment, each dividing wall includes a top edge, such that the dividing walls do not span the full height of the chamber. This allows open-air exchange between the different chambers.

The fourth chamber (or final chamber if the tank contains more or fewer than four chambers) includes discharge pump 65, controlled by pump float switch 70. Discharge port 30 and UV lightbath 60 are also included in the fourth chamber, whose functions will be explained below.

Each of the first two chambers 20a and 20b includes a bubble diffuser 50, positioned at aeration tank's bottom. Also in the first chamber 20a is float switch for aeration pump 55. One embodiment includes access ports 40 allowing for service access into aeration tank 10. Port 45 allows for wiring and air tubing needed for components such as the pumps.

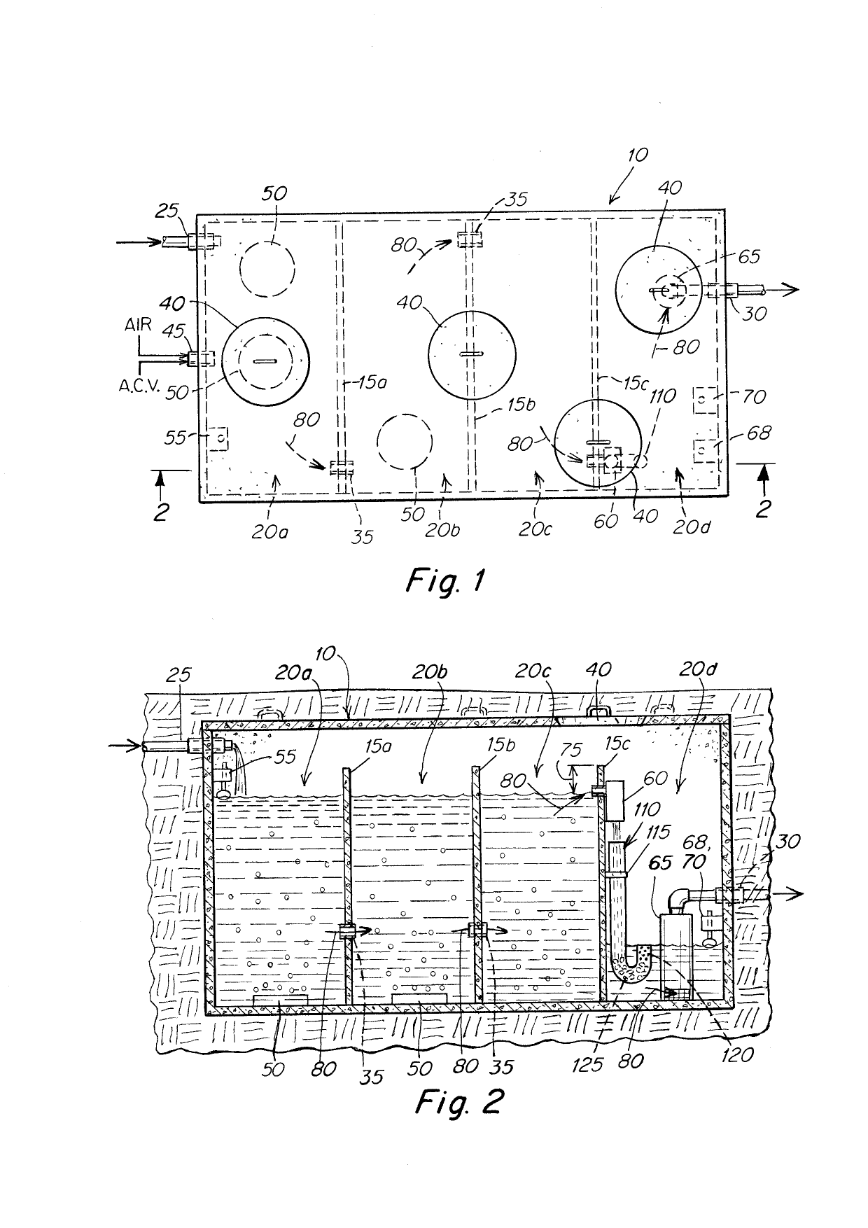

By positioning link port 25 near the top of each tank, filtered liquid waste, or effluent, enters chamber one from primary solids tank 5. As seen in FIG. 2, liquid waste may fill the first chamber until reaching the height of chamber port(s) 35. Upon reaching the required height of port 35, liquid may then travel to the second chamber, and in a similar process to the third chamber. FIG. 1 shows the staggered positioning of the chamber ports relative to one another across the different chambers. That is: the chamber port connecting chambers one and two is in a fore position, the chamber port connecting chambers two and three is in an aft position. This offset, or horizontally staggered chamber port configuration promotes optimal liquid flow within each chamber, insuring that liquid must travel through nearly the entire length of one chamber before entering the subsequent chamber. The ports are positioned in the same vertical alignment or plane. The liquid waste flow path is further shown by arrows 80. While one embodiment uses this staggered chamber port configuration, other chamber port configurations may also be used.

In one embodiment, each of the first two chambers includes a bubble diffuser 50, positioned at aeration tank's 10 bottom. Each diffuser 50 receives a supply of ambient fresh air from outside the tank from an aeration pump 56, which activated by float switch 55. The aeration pump may be located above-ground, outside of tank 10. Each aerator disperses bubbles in the liquid waste in each chamber, thereby promoting aerobic digestion of bacteria in the waste. Such aerobic digestion processes are known in the art, and will not be explained further here. The aerators serve both to infuse air/oxygen into the liquid, as well as to promote circulation of the waste liquid throughout the first two chambers. In one embodiment, an aeration pump is used. Other devices for delivering differential air pressure including but not limited to blowers and tanks of compressed gas air may also be used.

In one embodiment, the first and second chambers each include a bubble diffuser 50, but third chamber does not include a bubble diffuser 50. In this embodiment, the liquid waste in chambers one and two are aerated to promote aerobic digestion of bacteria in the liquid waste. The third chamber is not aerated to allow the liquids contents to settle.

When the level of liquid waste reaches the maximum capacity of the first three chambers, which by definition at equilibrium is the same height in each chamber, the liquid passes from the third chamber to the fourth chamber, also called the final chamber. At this transition, the liquid preferably passes through UV lightbath 60, which further serves to reduce bacteria in the liquid, where the liquid's bacteria has already undergone aerobic digestion in the first three chambers. In FIG. 2, the height of the liquid waste is shown as its maximum level, with the gap 75 shown from the maximum height of the liquid waste to the top of the dividing walls. As the liquid waste reaches its maximum level, it exits from the third chamber 20c to the fourth chamber 20d through a chamber port 35, where the exit of the chamber port includes UV lightbath 60.

UV lightbath 60 is included only in the final chamber, to kill remaining bacteria that have not been killed through the previous processes of aerobic digestion, etc. UV light is used only in the final treatment steps of the liquid waste, and not as part of the aerobic digestion process. This is deliberately so, as inclusion of UV light in the chambers in which aerobic digestion takes place would inhibit the aerobic digestion process by killing the beneficial microorganisms that consume unwanted bacteria. In one embodiment, the final chamber includes J-tube 110, which is held in place by bracket 115. Liquid discharged into the final chamber, and which then passes through UV lightbath 60, then travels into J-tube 110. J-Tube 110 may contain one or more anti-bacterial and/or anti-odor substances, such as limestone and charcoal. In one embodiment, an anti-bacterial substance 125 is positioned at the bottom of J-tube 110, with an anti-odor substance 120 positioned near the discharge end of J-tube 110. J-tube 110 may be removable, preferably sized to be removed through an access port 40, in order to refresh the anti-bacterial and anti-odor substances when each has reaching the end of its service life. Liquid exits the J-tube in a 180 degree orientation from which liquid enters the J-tube. The J-tube may be positioned to receive by gravity in a first end the liquid waste from the chamber port and discharge liquid waste from a second end into the final chamber, the J-tube configured with a 180 degree curve.

In one embodiment, plastic carriers 120 may be included with the tank chambers that include aerobic digestion and aeration, such as the first and second chambers. Carriers 120 are preferable of a density that allows floatation in the liquid waste. Such carriers are known in the art, and provide increased surface area for beneficial microorganisms that consume bacteria and organic material in the liquid waste. Thus, the number of beneficial microorganisms present in each chamber is increased by use of carriers 120.

In the fourth chamber, liquid accumulates to a height at which pump float switch 70 activates discharge pump 65. Pump 65 then transfers the fully treated liquid waste out of discharge port 30. Once the height of liquid in chamber four drops, float switch 70 deactivates pump 65. In one embodiment, the exit port is a 2 inch circular opening/coupling. Liquid exiting through discharge port 30 may then travel to a leach field, or to other appropriate treatment area. As previously described, the fully treated liquid may be low enough in bacteria to safely allow discharge into a leach field which would normally not meet the criteria for discharge from conventional, mound, or similar septic systems. Optionally, liquid may exit discharge port 30 through the force of gravity, with a discharge pump and its associated components not needed.

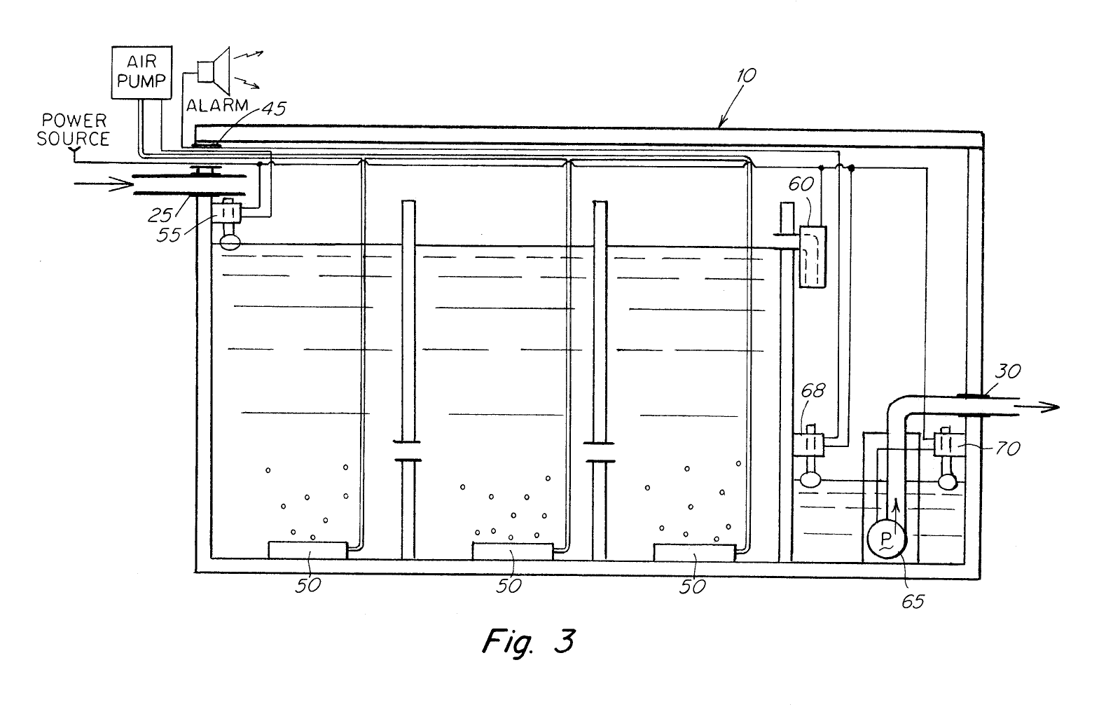

FIG. 3 shows a schematic of the electrical system of the present device. An external power source, such as from the electrical grid, a battery, or an energy-generating device such as a PV panel, supplies power to the system. Aeration pump switch 55, which may be controlled by the level of the liquid in the tank, time, or other factors, triggers the air pump 56 to activate. Air pump 56 then delivers a flow of air through lines to each bubble diffuser 50.

Electrical power is also routed to UV lightbath 60, and optional alarm 68. Alarm 68, if included, triggers an alarm (preferably external to the tank) to alert of a liquid in the fourth chamber than has exceeded an allowable level, caused by a blocked discharge port 30. Additional alarms may be used to alert if aeration pump 55 has failed, or if UV light 60 has failed. Any suitable type of alarm may be used, including audible types, visual/light types, or a type that alerts via the internet. Power also is routed to float switch 70 controlling pump 65.

Although the present system has been described with respect to one or more embodiments, it will be understood that other embodiments of the present system may be made without departing from the spirit and scope of the present system. Hence, the present system is deemed limited only by claims and the reasonable interpretation thereof.

What is claimed:

1. A device for treating sewage, comprising:
a closed-top primary solids tank directly receiving unfiltered sewage, with a filtering device positioned in the primary solids tank to create filtered liquid waste and prevent solid sewage from passing through a link port;
a closed-top aeration tank in fluid communication with the primary solids tank via the link port;
the aeration tank including at least one vertical dividing wall, the at least one vertical dividing wall forming at least a first chamber and a final chamber;
at least one chamber port which places the at least two chambers in fluid communication with one another;
an aeration pump connected to at least one bubble diffuser, the at least one bubble diffuser positioned at the aeration tank's bottom in only the first chamber;
a UV lightbath positioned in the aeration tank only in the final chamber; and
a discharge port through which treated liquid waste exits the aeration tank from the final chamber.

2. The device of claim 1, in which said the at least one vertical dividing wall is configured to span less than the aeration tank's full height, thereby creating open air exchange within the closed-top aeration tank between the chambers at each chamber's top portion, the filtered liquid waste traveling between the chambers only through the at least one chamber port, the chamber port located below a top edge of each said vertical dividing wall.

3. The device of claim 1, in which both the closed-top primary solids tank and the closed-top aeration tank are configured to be buried in the ground and are buried in the ground.

4. The device of claim 1, in which only the closed-top aeration tank includes insulation on its outside surface.

5. The device of claim 1, in which the final chamber contains a J-tube, the J-tube positioned to receive by gravity in a first end the liquid waste from the at least one chamber port and discharge liquid waste from a second end into the final chamber, the J-tube configured with a 180 degree curve.

6. The device of claim 5, in which the J-tube contains at least one of an anti-bacterial substance and an anti-odor substance.

7. A device for treating sewage, comprising:
a closed-top primary solids tank directly receiving unfiltered sewage, with a filtering device positioned in the primary solids tank to create filtered liquid waste and prevent solid sewage from passing through a link port;
a closed-top aeration tank in fluid communication with the primary solids tank via the link port;
the aeration tank including three vertical dividing walls, forming a first chamber, a second chamber, a third chamber, and a final chamber;
a chamber port in each vertical dividing wall which places: the first chamber in fluid communication with the second chamber, the second chamber in fluid communication with the third chamber; and the third chamber in fluid communication with the final chamber;
an aeration pump connected to at least one bubble diffuser, the at least one bubble diffuser positioned at the aeration tank's bottom;
a UV lightbath positioned in the aeration tank only in the final chamber; and
a discharge port located in the final chamber through which treated liquid waste is pumped by a discharge pump to exit the aeration tank.

8. The device of claim 7, in which all of the vertical dividing walls are configured to span less than the aeration tank's full height, thereby creating open air exchange within the closed-top aeration tank between the chambers at each chamber's top portion, the liquid waste traveling between the chambers only through the chamber ports, the chamber ports located below a top edge of each said vertical dividing wall.

9. The device of claim 7, in which both the closed-top primary solids tank and the closed-top aeration tank are configured to be buried in the ground and are buried in the ground.

10. The device of claim 7, in which only the closed-top aeration tank includes insulation on its outside surface.

11. The device of claim 7, in which the final chamber contains a J-tube, the J-tube positioned to receive by gravity in a first end the liquid waste from the third chamber and discharge liquid waste from a second end into the final chamber, the J-tube configured with a 180 degree curve.

12. The device of claim 11, in which the J-tube contains at least one of an anti-bacterial substance and an anti-odor substance.

13. The device of claim 11, in which the J-tube is sized to be removable through an access port to the final chamber.

14. The device of claim 7, in which a bubble diffuser of the least one bubble diffuser is included at a bottom of only the first chamber and the second chamber.

15. The device of claim 7, in which the chamber ports are configured on each vertical dividing wall in positions that are vertically aligned and horizontally staggered fore-aft relative to the other chamber port in that chamber.

15. The device of claim 7, in which the discharge pump includes a float switch for cycling the discharge pump on and off.

16. The device of claim 7, in which an alert signals if liquid in the final chamber has exceeded an allowable level.

17. The device of claim 7, in which carriers are included in only the first chamber and the second chamber.

18. The device of claim 7, in which malfunctions related to the aeration pump and the UV light are signaled with an alert.

19. A method for treating sewage, comprising:
placing a closed-top primary solids tank to directly receive unfiltered sewage, with a filtering device positioned in the primary solids tank to create filtered liquid waste and prevent solid sewage from passing through a link port;
placing a closed-top aeration tank in fluid communication with the primary solids tank via the link port;
configuring the aeration tank including at least one vertical dividing wall, the at least one vertical dividing wall forming at least a first chamber and a final chamber;
configuring at least one chamber port which places the at least two chambers in fluid communication with one another;
connecting an aeration pump to at least one bubble diffuser, the at least one bubble diffuser positioned at the aeration tank's bottom in only the first chamber;
configuring a UV lightbath in the aeration tank only in the final chamber; and
pumping out the aeration tank's contents out of the discharge port with a discharge pump, the discharge pump controlled by a float switch.
